(19) United States
(12) Patent Application Publication
(10) Pub. No.: US 2026/0349983 A1
(43) Pub. Date: Nov. 5, 2026

(54) SYSTEMS AND METHODS FOR FAST FLOATING-POINT SEARCH AND SIMILARITY

(71) Applicant: Daniel J. Feldman, Lenox, MA (US)

(72) Inventor: Daniel J. Feldman, Lenox, MA (US)

(21) Appl. No.: 19/532,740

(22) Filed: Feb. 6, 2026

Related U.S. Application Data
(60) Provisional application No. 63/797,872, filed on Apr. 30, 2025.

(51) Int. Cl. G06F 16/22; G06F 16/2453; G06F 16/248

(52) U.S. Cl. CPC G06F 16/2237; G06F 16/24549; G06F 16/248

(57) ABSTRACT

Disclosed herein are computer systems and methods to search a dataset including digital floating-point numbers organized in columns and rows in order to find rows that match or come close to matching a target sequence of digital floating-point numbers. Floating-point representations of real numbers encode the numbers in three components: a sign, an exponent, and a mantissa. The disclosed systems and methods treat the exponent and the mantissa as two separate, indexable entities. That is, each value in a floating-point column is treated as two values (or sub-columns) and each sub-column can be indexed. Computer system acceleration can be achieved by using a bit-map index for the exponent and, in some cases, the mantissa. Operating on only one of the values (e.g., the exponent) first can significantly reduce the search space and accelerate searching of large datasets.

### CROSS-REFERENCE TO RELATED APPLICATIONS

This application claims the benefit of U.S. Provisional Application No. 63/797,872, entitled “SYSTEMS AND METHODS FOR FAST FLOATING-POINT SEARCH AND SIMILARITY,” filed on Apr. 30, 2025. The entire contents of this application are incorporated by reference herein.

### FIELD

This disclosure relates generally to digital data processing and, more particularly, to systems and methods for searching large data sets of floating-point numbers for nearest neighbors to a target vector of floating-point numbers.

### BACKGROUND

Vector database management systems have emerged as key technologies in the development of commercially important computing systems that operate on large quantities of real numbers organized as lists (vectors) of those numbers stored and operated on using industry standard floating-point representation. The vectors themselves can be quite large. For example, the current generation of natural language processing applications, including large language models (LLMs) and LLMs enhanced to support retrieval augmented generation (RAG) can be built using vectors of a thousand or more elements (dimensions). LLMs and RAG are key technologies in contemporary generative AI applications used for tasks ranging from textual and graphical content creation to scientific discovery and robotics.

The key operations that vector database management systems perform in the operation of vector-based applications are storing vectors in a reliable and persistent manner and retrieving vectors or sets of vectors that match or are similar to an input target vector. Searching vector databases containing hundreds of millions of rows (vectors) and hundreds of millions of columns (dimensions) is complex in both time and space. The task of retrieving vectors that are similar to a specific target is especially challenging in datasets where the number of elements in a vector, that is, the number of dimensions encoded in the vector, is large. Many existing vector database management systems attempt to address this retrieval challenge by building indexes on the data that encode information about the relative position in multi-dimensional space of the indexed vectors. These systems, however, still suffer from efficiency challenges as the size of data sets involved continues to increase. In addition, typical prior approaches utilize either brute force searching, which can be unusably slow for many applications, or techniques that gain speed by sacrificing accuracy and delivering approximate results (i.e., not guaranteed to deliver the nearest neighbor to a search target).

Accordingly, there is a need for improved systems and methods for searching large datasets of floating-point numbers for nearest neighbors to a target vector of floating-point numbers.

### SUMMARY

Described herein are systems and methods for optimizing the operation of computer systems that search a dataset including floating-point numbers organized in columns and rows in order to find rows that match or come close to matching a target sequence of floating-point numbers. For convenience, the rows of the table containing the sets of floating-point numbers are called vectors and the columns are called dimensions herein; the software component of the system that searches, retrieves, and matches the target is called a vector database manager herein.

The systems and methods disclosed herein approach the retrieval problem as a large-scale data search and filtering problem by providing indexes that are specialized for floating-point numbers, thereby enabling rapid searching. By doing so, some components of the process of assessing similarity are removed from the index itself, allowing the user to optimize the choice of similarity assessment algorithm for the nature of their specific application.

Further, floating-point representations of real numbers encode the numbers in three components: a sign, an exponent, and a mantissa. The disclosed systems and methods of computer system acceleration treat the exponent and the signed mantissa as two separate, indexable entities. That is, each value in a floating-point column is treated as two values (or sub-columns) and each sub-column can be indexed. Search operations can be accelerated by operating on the exponent and mantissa separately in various manners. For example, in some embodiments a search can utilize a bit-map index of an exponent of the floating-point numbers to find rows with an exponent within a first range of the exponent in the target vector. This can effectively quantize the data set and reduce the search space significantly. Additional searching can then be performed, for example, using brute force searching on the full floating-point values or on only the mantissa, or using a bit-map index of the mantissa of the floating-point numbers, to find rows within a second range of the target vector (e.g., rows with a full floating-point value within a second range of the target vector or rows with a mantissa within a second range of the mantissa in the target vector). The final found set of vectors can be ranked, for example, by multi-dimensional distance to the target vector, and one or more of the nearest neighbors (i.e., closest in multi-dimensional space) can be returned as search results.

The disclosed systems and methods provide technical solutions to technical problems with floating-point number similarity searching. Searching large datasets of floating-point vectors is computationally expensive because comparisons of floating-point vectors can involve complex binary representations. Existing similarity searches may require scanning every row, which is highly inefficient for high-dimensional data. Moreover, existing indexing methods for integers or strings may not work well for floating-point data due to the precision and representation complexity. Brute force similarity searching across millions of vectors can also consume excessive CPU cycles and memory, thereby bogging available compute resources.

Without specialized indexing techniques, as described herein, existing systems would perform matching operations including computing multi-dimensional distances for every candidate row, scaling poorly, and clogging compute resources. Alternatively, exiting systems utilize search techniques that increase speed or reduce computational complexity by sacrificing accuracy, such that they deliver approximate matches, i.e., they are not guaranteed to produce the nearest neighbor match to a search target.

The disclosed systems and methods also provide technical advantages in treating the exponent and the mantissa of floating-point numbers as separate indexable entities. This allows for quantization of a search space to quickly narrow candidates and reduce complexity, both of which greatly accelerate search operations compared to brute-force techniques. The disclosed systems and methods further provide for potential use of a two-stage search process with coarse filtering and fine filtering, which provides advantages in reducing compute load and memory usage (such as by eliminating irrelevant candidates early in the process). After filtering, nearest neighbors can be ranked using optimized algorithms for high-dimensional spaces, thereby resulting in improved accuracy and performance in different applications and use cases.

None of the techniques described herein can be performed in the human mind or with pen and paper. For example, the human mind does not have the cognitive capacity nor capability to parse binary floating-point representations at scale, maintain and operate bitmap indexes across millions of vectors, or compute multidimensional distances for large datasets in real-time. The disclosed technology, on the other hand, requires high speed processors, memory management, and parallel computation with specialized data structures, all of which cannot be performed in the human mind. Accordingly, the disclosed technology improves the functioning of computer systems by providing faster searches and reduced resource usage. The disclosed technology also solves technical problems rooted in computer technologies by providing efficient floating-point number similarity searching. Moreover, the disclosed technology is not a generic algorithm-rather, it implements specific data structures and representation-aware optimizations to provide a concrete improvements in computer performance.

In one aspect, a method for accelerating search and similarity matching of arrays of digital floating-point numbers (of some specified precision) using bit mapped indexes can be provided that treats the exponent and the mantissa of each floating-point element of the array as two separately indexable components, the exponent and the mantissa.

Any of a variety of alternative or additional features can be included and are considered within the scope of the present disclosure. For example, in some embodiments, the exponent of each column of the array can be indexed using a low-cardinality bit-map index. In certain embodiments, the mantissa of each column of the array can be indexed using a low-cardinality bit-map index. In other embodiments, the mantissa of each column of the array can be indexed using a high-cardinality bit-map index.

In another aspect, a vector database management system can be provided that implements the method of the above-noted aspect as an indexing and search method for retrieving a set of vectors in a dataset stored in a database that are most similar to a target vector presented as an argument to the system.

In another aspect, a method for searching an array of digital floating-point numbers arranged in columns and rows for a nearest neighbor to a target vector can include receiving a target vector of digital floating-point numbers having a number of dimensions that matches a number of columns in an array of digital floating-point numbers. The method can further include iterating over each column of the array of digital floating-point numbers using a bit-map index of an exponent of each floating-point number in a selected column to identify each row of the array that contains an exponent within a first range of an exponent of a floating-point number in the corresponding dimension of the target vector and storing each identified row in a column exponent found set bit-map on a digital data memory. The method can further include combining each column exponent found set bit-map using a logical AND function to create a final exponent found set bit-map. The method can also include storing the final exponent found set bit-map on the digital data memory, the final exponent found set bit-map identifying rows in the array where the exponent of the floating-point number in each column of each identified row is within the first range of the exponent of the floating-point number in the corresponding dimension of the target vector.

As with the above-noted aspects, any of a variety of alternative or additional features can be included and are considered within the scope of the present disclosure. For example, in some embodiments, iterating over each column of the array of digital floating-point numbers using a bit-map index of an exponent of each floating-point number in a selected column to identify each row of the array that contains an exponent within a first range of an exponent of a floating-point number in the corresponding dimension of the target vector and storing each identified row in a column exponent found set bit-map can include, for each column: storing each identified row having an exponent within the first range of an exponent of a floating-point number in the corresponding dimension of the target vector in an interim column exponent found set bit-map. The method step can further include combining each interim column exponent found set bit-map using a logical OR function to create the column exponent found set bit-map.

In certain embodiments, the method can further include brute-force searching a mantissa of each digital floating-point number in each row identified in the final exponent found set bit-map to identify each row that contains a mantissa within a second range of a mantissa of a floating-point number in the corresponding dimension of the target vector and storing each identified row in a final found set bit-map. The method can also include storing the final found set bit-map on the digital data memory, the final found set bit-map identifying rows in the array where the exponent of the floating-point number in each column of each identified row is within the first range of the exponent of the floating-point number in the corresponding dimension of the target vector and the mantissa of the floating-point number in each column of each identified row is within the second range of the mantissa of the floating-point number in the corresponding dimension of the target vector.

In some embodiments, the method can include brute-force searching each digital floating-point number in each row identified in the final exponent found set bit-map to identify each row that contains a floating-point number within a second range of a floating-point number in the corresponding dimension of the target vector and storing each identified row in a final found set bit-map. The method can also include storing the final found set bit-map on the digital data memory, the final found set bit-map identifying rows in the array where the exponent of the floating-point number in each column of each identified row is within the first range of the exponent of the floating-point number in the corresponding dimension of the target vector and the floating-point number in each column of each identified row is within the second range of the floating-point number in the corresponding dimension of the target vector.

In certain embodiments, the method can further include iterating over each column of each row identified in the final exponent found set bit-map using a bit-map index of a mantissa of each floating-point number in a selected column to identify each row of the array that contains a mantissa within a second range of a mantissa of a floating-point number in the corresponding dimension of the target vector and storing each identified row in a column mantissa found set bit-map. The method can also include combining each column mantissa found set bit-map using a logical AND function to create a final found set bit-map. The method can further include storing the final found set bit-map on a digital data memory, the final found set bit-map identifying rows in the array where the exponent of the floating-point number in each column of each identified row is within the first range of the exponent of the floating-point number in the corresponding dimension of the target vector and the mantissa of the floating-point number in each column of each identified row is within the second range of the mantissa of the floating-point number in the corresponding dimension of the target vector. In some embodiments, iterating over each column of each row identified in the final exponent found set bit-map using a bit-map index of a mantissa of each floating-point number in a selected column to identify each row of the array that contains a mantissa within a second range of a mantissa of a floating-point number in the corresponding dimension of the target vector and storing each identified row in a column mantissa found set bit-map can include, for each column: storing each identified row having a mantissa within the second range of a mantissa of a floating-point number in the corresponding dimension of the target vector in an interim column mantissa found set bit-map. The method step can include combining each interim column mantissa found set bit-map using a local OR function to create the column mantissa found set bit-map.

In some embodiments, the method can further include calculating for each row identified in the final found set bit-map a distance to the target vector and storing the calculated distance on a digital data memory. In certain embodiments, calculating for each row identified in the final found set bit-map a distance to the target vector can be performed using a Graphics Processing Unit (GPU) of a computer system.

In certain embodiments, the method can further include sorting the rows identified in the final found set bit-map by the calculated distance in ascending order and outputting one or more of the top rows as a nearest neighbor to the target vector.

In some embodiments, the exponent of each floating-point number in the array can be indexed using a low-cardinality bit-map index. In certain embodiments, the mantissa of each floating-point number in the array can be indexed using a low-cardinality bit-map index. In other embodiments, the mantissa of each floating-point number in the array can be indexed using a high-cardinality bit-map index.

In certain embodiments, bit-map operations can be performed using a programmable storage controller of one or more storage devices. In some embodiments, bit-map operations can be performed using a vector processing unit of a Central Processing Unit (CPU). In certain embodiments, bit-map operations can be performed using a Graphics Processing Unit (GPU).

In another aspect, a method for accelerating search of digital floating-point numbers arranged in columns and rows for a nearest neighbor to a target vector can include receiving an array of digital floating-point numbers arranged in columns and rows. The method can also include creating a bit-map index of an exponent of each floating-point number in the array, as well as storing the bit-map index on a digital data memory.

Any of a variety of alternative or additional features can be included and are considered within the scope of the present disclosure. For example, in some embodiments, the bit-map index can be a low-cardinality bit-map index.

In certain embodiments, the method can further include creating a second bit-map index of a mantissa of each digital floating-point number in the array and storing the second bit-map index on the digital data memory. In some embodiments, the second bit-map index can be a low-cardinality bit-map index. In other embodiments, the second bit-map index can be a high-cardinality bit-map index.

In another aspect, a system for vector database management can include a digital data processor, and a digital data memory having an array of digital floating-point numbers and a bit-map index of an exponent of each floating-point number in the array stored thereon. The digital data processor can be configured to receive a target vector of digital floating-point numbers having a number of dimensions that matches a number of columns in the array of digital floating-point numbers. The digital data processor can be further configured to iterate over each column of the array of digital floating-point numbers using the bit-map index of the exponent of each floating-point number in a selected column to identify each row of the array that contains an exponent within a first range of an exponent of a floating-point number in the corresponding dimension of the target vector and store each identified row in a column exponent found set bit-map on the digital data memory. The digital data processor can also be configured to combine each column exponent found set bit-map using a logical AND function to create a final exponent found set bit-map. The digital data processor can also be configured to store the final exponent found set bit-map on the digital data memory, the final exponent found set bit-map identifying rows in the array where the exponent of the floating-point number in each column of each identified row is within the first range of the exponent of the floating-point number in the corresponding dimension of the target vector.

Any of a variety of alternative or additional features can be included and are considered within the scope of the present disclosure. For example, in some embodiments, the digital data processor can be further configured to brute-force search a mantissa of each floating-point number in each row identified in the final exponent found set bit-map to identify each row that contains a mantissa within a second range of a mantissa of a floating-point number in the corresponding dimension of the target vector and store each identified row in a final found set bit-map. The digital data processor can also be configured to store the final found set bit-map on the digital data memory, the final found set bit-map identifying rows in the array where the exponent of the floating-point number in each column of each identified row is within the first range of the exponent of the floating-point number in the corresponding dimension of the target vector and the mantissa of the floating-point number in each column of each identified row is within the second range of the mantissa of the floating-point number in the corresponding dimension of the target vector.

In certain embodiments, the digital data processor can be further configured to brute-force search each floating-point number in each row identified in the final exponent found set bit-map to identify each row that contains a floating-point number within a second range of a floating-point number in the corresponding dimension of the target vector and store each identified row in a final found set bit-map. The digital data processor can also be configured to store the final found set bit-map on the digital data memory, the final found set bit-map identifying rows in the array where the exponent of the floating-point number in each column of each identified row is within the first range of the exponent of the floating-point number in the corresponding dimension of the target vector and the floating-point number in each column of each identified row is within the second range of the floating-point number in the corresponding dimension of the target vector.

In some embodiments, the digital data memory can have a second bit-map index of a mantissa of each floating-point number in the array stored thereon and the digital data processor is further configured to iterate over each column of each row identified in the final exponent found set bit-map using the bit-map index of the mantissa of each floating-point number in a selected column to identify each row of the array that contains a mantissa within a second range of a mantissa of a floating-point number in the corresponding dimension of the target vector and store each identified row in a column mantissa found set bit-map. The digital data processor can be further configured to combine each column mantissa found set bit-map using a logical AND function to create a final found set bit-map. The digital data processor can also be configured to store the final found set bit-map on the digital data memory, the final found set bit-map identifying rows in the array where the exponent of the floating-point number in each column of each identified row is within the first range of the exponent of the floating-point number in the corresponding dimension of the target vector and the mantissa of the floating-point number in each column of each identified row is within the second range of the mantissa of the floating-point number in the corresponding dimension of the target vector.

In certain embodiments, the digital data processor can be further configured to calculate for each row identified in the final found set bit-map a distance to the target vector and store the calculated distance on the digital data memory. The digital data processor can be further configured to sort the rows identified in the final found set bit-map by the calculated distance in ascending order and output one or more of the top rows as a nearest neighbor to the target vector.

In some embodiments, the exponent of each floating-point number in the array can be indexed using a low-cardinality bit-map index. In certain embodiments, the mantissa of each floating-point number in the array can be indexed using a low-cardinality bit-map index. In other embodiments, the mantissa of each floating-point number in the array can be indexed using a high-cardinality bit-map index.

In another aspect, a non-transitory computer-readable medium can be provided that stores instructions that, when executed by one or more processors, can cause the one or more processors to perform operations including receiving a target vector of digital floating-point numbers having a number of dimensions that matches a number of columns in an array of digital floating-point numbers arranged in columns and rows. The operations can further include iterating over each column of the array of digital floating-point numbers using a bit-map index of an exponent of each floating-point number in a selected column to identify each row of the array that contains an exponent within a first range of an exponent of a floating-point number in the corresponding dimension of the target vector and storing each identified row in a column exponent found set bit-map on a digital data memory. The operations can further include combining each column exponent found set bit-map using a logical AND function to create a final exponent found set bit-map. The operations can also include storing the final exponent found set bit-map on a digital data memory, the final exponent found set bit-map identifying rows in the array where the exponent of the floating-point number in each column of each identified row is within the first range of the exponent of the floating-point number in the corresponding dimension of the target vector.

Any of a variety of alternative or additional features can be included and are considered within the scope of the present disclosure. For example, in some embodiments, the instructions, when executed by the one or more processors, can further cause the one or more processors to brute-force search a mantissa of each floating-point number in each row identified in the final exponent found set bit-map to identify each row that contains a mantissa within a second range of a mantissa of a floating-point number in the corresponding dimension of the target vector and store each identified row in a final found set bit-map. The instructions can further cause the one or more processors to store the final found set bit-map on the digital data memory, the final found set bit-map identifying rows in the array where the exponent of the floating-point number in each column of each identified row is within the first range of the exponent of the floating-point number in the corresponding dimension of the target vector and the mantissa of the floating-point number in each column of each identified row is within the second range of the mantissa of the floating-point number in the corresponding dimension of the target vector.

Any of a variety of alternative or additional features can be included and are considered within the scope of the present disclosure. For example, in some embodiments, the instructions, when executed by the one or more processors, can further cause the one or more processors to brute-force search each floating-point number in each row identified in the final exponent found set bit-map to identify each row that contains a floating-point number within a second range of a floating-point number in the corresponding dimension of the target vector and store each identified row in a final found set bit-map. The instructions can further cause the one or more processors to store the final found set bit-map on the digital data memory, the final found set bit-map identifying rows in the array where the exponent of the floating-point number in each column of each identified row is within the first range of the exponent of the floating-point number in the corresponding dimension of the target vector and the floating-point number in each column of each identified row is within the second range of the floating-point number in the corresponding dimension of the target vector.

In certain embodiments, the instructions, when executed by the one or more processors, can further cause the one or more processors to iterate over each column of each row identified in the final exponent found set bit-map using the bit-map index of the mantissa of each floating-point number in a selected column to identify each row of the array that contains a mantissa within a second range of a mantissa of a floating-point number in the corresponding dimension of the target vector and store each identified row in a column mantissa found set bit-map. The instructions can further cause the one or more processors to combine each column mantissa found set bit-map using a logical AND function to create a final found set bit-map. The instructions can also cause the one or more processors to store the final found set bit-map on the digital data memory, the final found set bit-map identifying rows in the array where the exponent of the floating-point number in each column of each identified row is within the first range of the exponent of the floating-point number in the corresponding dimension of the target vector and the mantissa of the floating-point number in each column of each identified row is within the second range of the mantissa of the floating-point number in the corresponding dimension of the target vector.

In some embodiments, the instructions, when executed by the one or more processors, further cause the one or more processors to calculate for each row identified in the final found set bit-map a distance to the target vector and store the calculated distance on the digital data memory. In certain embodiments, the instructions, when executed by the one or more processors, can further cause the one or more processors to sort the rows identified in the final found set bit-map by the calculated distance in ascending order and output one or more of the top rows as a nearest neighbor to the target vector.

In certain embodiments, the exponent of each floating-point number in the array can be indexed using a low-cardinality bit-map index. In some embodiments, the mantissa of each floating-point number in the array can be indexed using a low-cardinality bit-map index. In other embodiments, the mantissa of each floating-point number in the array can be indexed using a high-cardinality bit-map index.

Any of the features or variations described herein can be applied to any particular aspect or embodiment of the present disclosure in a number of different combinations. The absence of explicit recitation of any particular combination is due solely to avoiding unnecessary length or repetition.

### BRIEF DESCRIPTION OF THE DRAWINGS

The aspects and embodiments of the present disclosure can be more fully understood from the following detailed description taken in conjunction with the accompanying drawings, in which:

FIG. 1 is an illustration of one embodiment of a computer vector processing system;

FIG. 2 is an illustration of one embodiment of a vector database management system;

FIG. 3 is an illustration of one embodiment of a vector database logical organization;

FIG. 4 is an illustration of one embodiment of a vector database table logical organization;

FIG. 5 is an illustration of one embodiment of a logical index like that shown in FIG. 4;

FIG. 6 is an illustration of one embodiment of a low cardinality bit-map index for a floating-point number exponent;

FIG. 7 is an illustration of one embodiment of a logical bit-map;

FIG. 8 is an illustration of one embodiment of a high-cardinality bit-map index for a floating-point number sign and mantissa;

FIG. 9 is a flow chart of one embodiment of a method according to the present invention;

FIG. 10 is a flow chart of one embodiment of a method according to the present invention extending from FIG. 9;

FIG. 11 is a flow chart of one embodiment of a method according to the present invention extending from any of FIG. 9 or 10;

FIG. 12 is a flow chart of one embodiment of a method according to the present invention extending from any of FIG. 9 or 10;

FIG. 13 is a flow chart of one embodiment of a method according to the present invention extending from FIG. 12;

FIG. 14 is a flow chart of one embodiment of a method according to the present invention extending from any of FIGS. 11-13;

FIG. 15 is a flow chart of one embodiment of a method according to the present invention extending from FIG. 14; and

FIG. 16 is a flow chart of one embodiment of a method according to the present invention.

### DETAILED DESCRIPTION

Certain example embodiments will now be described to provide an understanding of the principles of the structure, function, and use of the systems and methods disclosed herein. One or more examples of these embodiments are illustrated in the accompanying drawings. The systems and methods specifically described herein and illustrated in the accompanying drawings are non-limiting embodiments. The features illustrated or described in connection with one embodiment may be combined with the features of other embodiments. Such modifications and variations are intended to be included within the scope of the present disclosure.

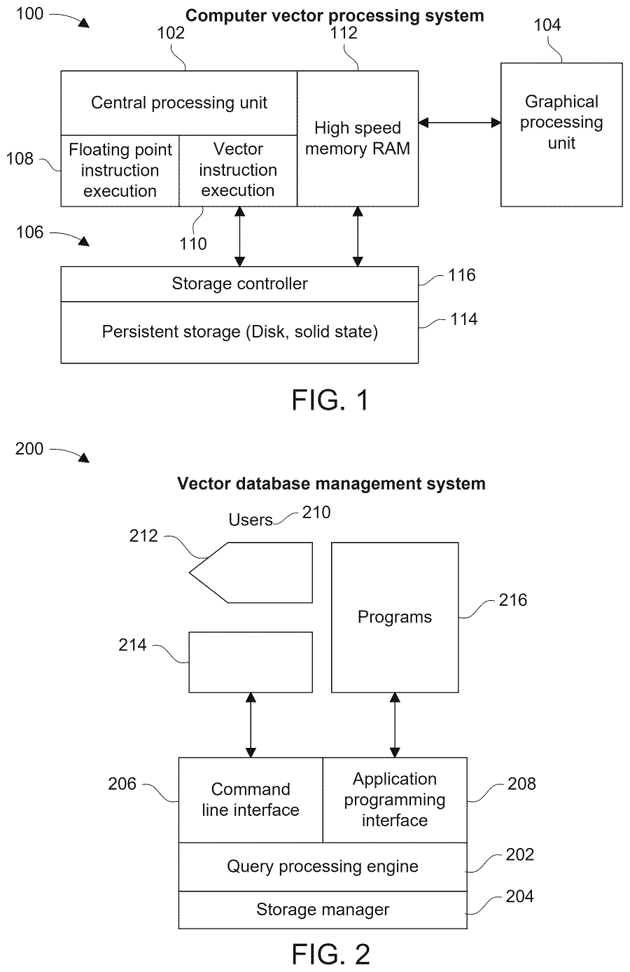

Certain aspects of the present disclosure can be embodied as a system, e.g., vector processing system 100 shown in FIG. 1. The system 100 can be implemented in hardware, software, firmware, or combinations of hardware, software, and/or firmware. In some examples, the system and methods described herein can be implemented using a non-transitory computer-readable medium storing computer executable instructions that, when executed by one or more processors of a computer, cause the one or more processors or computer to perform described operations.

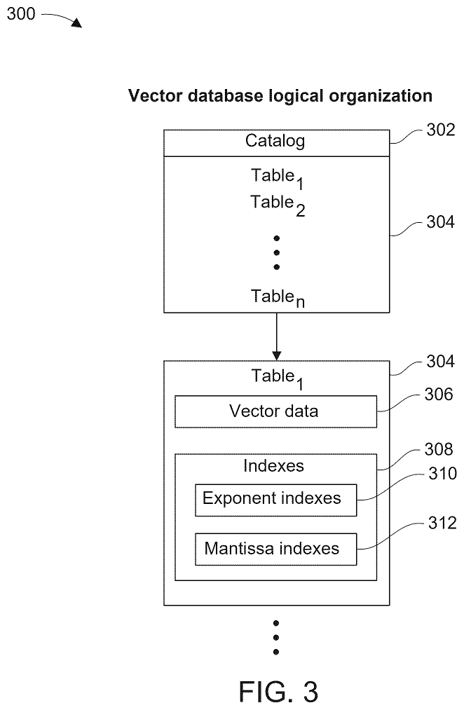

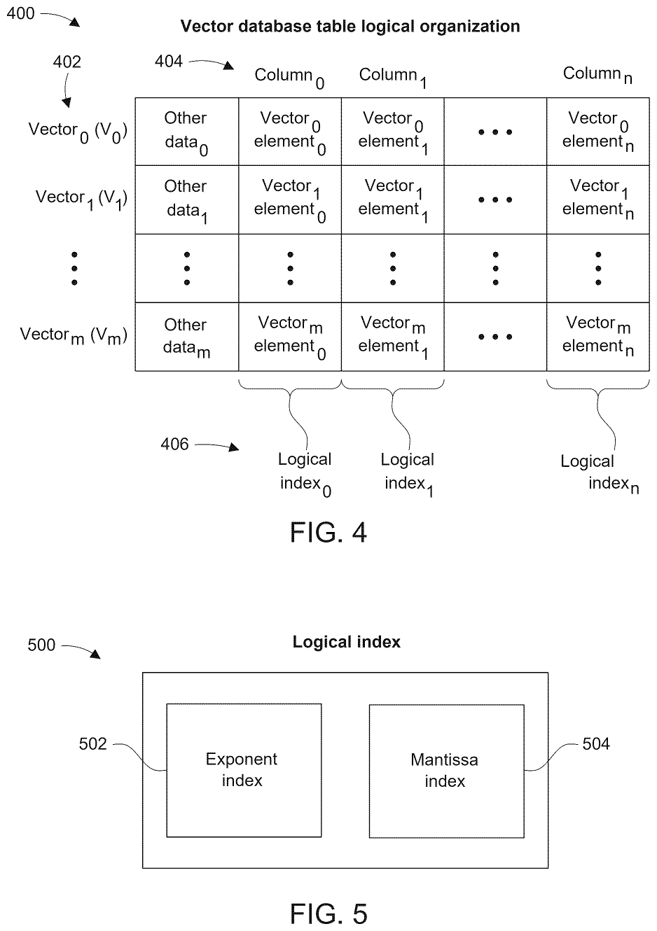

The systems and methods disclosed herein can optimize the operation of computer systems that search a dataset including floating-point numbers organized in columns and rows in order to find rows that match or come close to matching a target sequence of floating-point numbers. For convenience, the rows of the table containing the sets of floating-point numbers are referred to as vectors, the columns of the table are referred to as dimensions, and the software component of the system that searches, retrieves, and matches the target is referred to as a vector database manager or management system. Such systems can be executed using a computer vector processing system. See, e.g., the computer vector processing system 100 of FIG. 1, vector database management system of FIG. 2, vector database logical organization of FIG. 3, and vector database table logical organization of FIG. 4.

The computer vector processing system 100 shown in FIG. 1 can include a central processing unit (CPU) 102, a graphical processing unit (GPU) 104, and a data storage device 106. The central processing unit 102 can include various capabilities for working with floating-point numbers and vectors, such as floating-point instruction execution 108, and vector instruction execution 110. The central processing unit 102 can also be coupled to high speed memory, such as random access memory (RAM) 112. The data storage device 106 can include a persistent data storage medium 114, such as a hard disk drive (HDD) or solid state drive (SSD), as well as a storage controller 116. The various components of the system can be in communication with one another in a variety of combinations, one example of which is shown by the double-ended arrows in FIG. 1.

FIG. 2 illustrates one embodiment of a vector database management system 200. The system 200 can include various components, such as a query processing engine 202 and a storage manager 204. The query processing engine 202 can receive commands for performing queries from various sources, including a command line interface 206 and application programming interface (API) 208. The command line interface 206 can be utilized to interact with users 210 directly via an interface, such as a display 212 and keyboard 214 or other input device. The application programming interface 208 can be utilized to interact with other programs or software 216.

FIG. 3 illustrates one embodiment of a vector database logical organization 300. The vector database can include a catalog 302 of tables 304. Each table 304 (e.g., table 1, table 2, to table n) can include vector data 306 consisting of floating-point numbers listed in columns and rows, as well as various bit-map indexes 308 of the vector data. Floating-point representations of real numbers encode the numbers in three components: a sign, an exponent, and a mantissa. The bit-map indexes 308 can include a bit-map index 310 of the exponents of the floating-point numbers included in the vector data 306. The bit-map indexes 308 can also include a bit-map index 312 of the mantissas of the floating-point numbers included in the vector data 306.

FIG. 4 illustrates one embodiment of a vector database table logical organization 400, e.g., a logical organization of table 304 in FIG. 3. The vector database table can include a listing of vectors 402 as rows of the table, and each vector 402 (e.g., vector₀, vector₁, to vectorₘ) can have a series of columns 404 (e.g., column₀, column₁, to columnₙ) listing dimensions or elements of the vector (e.g., vector₀element₀, vector₀element₁, etc.). Additional data can also be stored as additional columns for each vector (e.g., other data₀, other data₁, to other dataₙ). Logical indexes 406 can summarize the information stored in each column or dimension 404 of the table 304 (e.g., logical index₀, logical index₁, to logical indexₙ).

As noted above, floating-point representations of real numbers encode the numbers in three components: a sign, an exponent, and a mantissa. The disclosed method of computer system acceleration treats the exponent and the signed mantissa as two separate, indexable entities. That is, each value in a floating-point column is treated as two values (or sub-columns) and each sub-column can be indexed. See, e.g., the logical index representation of FIG. 5. Each logical index 500 can include an exponent index 502 of the exponents of each floating-point value in a dimension or column of a vector database table. Each logical index 500 can also include a mantissa index 504 of the mantissa of each floating-point value in a dimension or column of a vector database table.

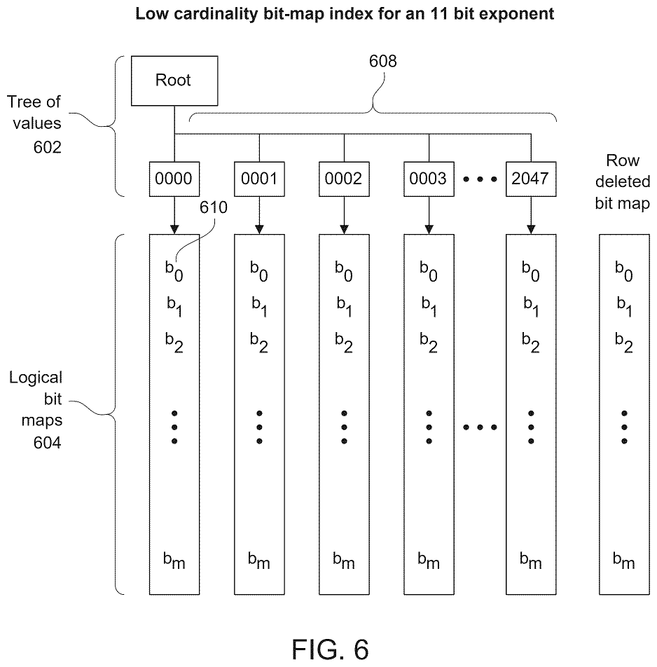

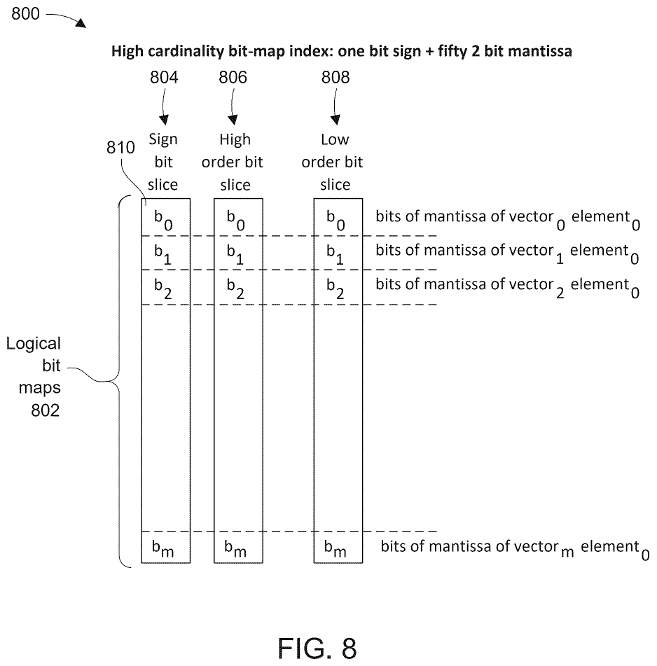

Computer system acceleration can be achieved by using a bit-map index optimized for low cardinality data to index the exponent and, in some cases, the mantissa. In some cases, the mantissa can be indexed with a bit-map index optimized for low cardinality data and, in other cases, using a bit-map index optimized for high cardinality data. The operation of low-and high-cardinality bit-map indexes are described below. See also, e.g., the low cardinality bit-map index for an exponent in FIG. 6 and the high cardinality bit-map index for a mantissa in FIG. 8.

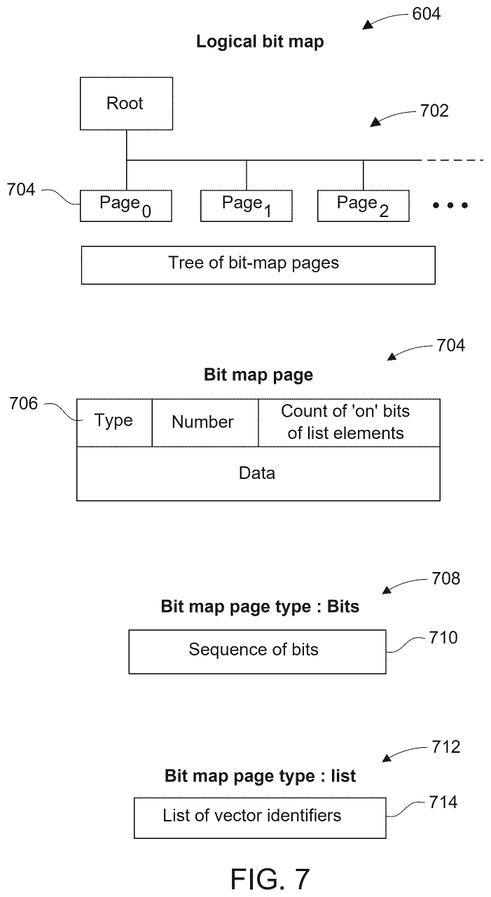

More generally, FIG. 7 illustrates one embodiment of a logical bit-map 604. The bit-map contains a sequence of bits. For large bit-maps—those with millions or billions of bits—the bit-map can be organized as a tree of pages 704 and each page can be present or not. A page in such a tree would be absent if all of its values were the same, as that entire page can be represented by a single bit in the parent node. Further, in certain cases the number of logical operations can be reduced by storing a list of integers rather than a sequence of bits in the bit-map. This can result in two types of bit-map pages 704: bits and lists. FIG. 7 shows example implementations of each type, including a bit-map page type 708 that includes a sequence of bits 710, as well as a bit-map page type 712 that includes a list of vector identifiers 714, which can be integer values. The different types of bit-map pages 704 can be differentiated by the presence of a type identifier 706 that is part of the page header section of each bit-map page 704.

FIG. 6 illustrates one embodiment of a low cardinality bit-map index 600 for an example 11-bit floating-point number exponent. The index 600 can include a tree of values 602 listing logical bit-maps 604 for each available bit 608 of the exponent. The logical bit-maps identify those vectors or rows in the vector database table where an exponent of a particular dimension has a matching bit, e.g., via a “0” or “1” binary indication stored in values 610 (e.g., b₀, b₁, b₂, to bₘ). The bit-map index 600 can also include a deleted row bit-map 612 that can be utilized to indicate if a particular row or vector has been deleted. If the row is present, for example, then the corresponding deleted bit can be ON. If the row has been deleted, then the corresponding deleted bit can be OFF. As explained in more detail below, matching operations can logically AND the deleted row bit-map with other data in order to exclude the deleted row from a matching process due to the deleted bit being OFF (e.g., 0). A low cardinality bit-map index (e.g., index 600) can be composed of a tree of values 702 where the leaves of the tree are bit-maps. For each value in the tree, the leaf bit-map can contain a bit for each row in the indexed table. If an indexed cell of an indexed column of the table has a value corresponding to a node that the leaf is attached to, then the bit for the row of that cell is ON in the bit-map. If the value does not correspond to a node that the leaf is attached to, then the bit for the row of that cell is OFF in the bit-map.

FIG. 8 illustrates one embodiment of a high cardinality bit-map index 800. A high cardinality bit-map is an array of bit-maps where each bit-map corresponds to one bit position in the storage representation of the data indexed. The highest order bit in the data is associated with a bit-map that has a one for each row in the indexed column in which the high order bit is ON. The second highest order bit in the data is associated with a bit-map that has a one for each row in the indexed column in which the second highest order bit is ON and so forth for the precision of the indexed column. These bit-maps can be the same as the bit-maps used in the construction of the low cardinality index.

High cardinality bit-map indexes can be beneficial for use with the mantissa due to its longer length. While FIG. 6 illustrates an example low cardinality bit-map index for an 11-bit floating-point number exponent, an example mantissa can include one bit to represent its sign and fifty-two bits to represent its value, i.e., it can be significantly larger than the above-noted example exponent. The bit-map index 800 can include a series of logical bit-maps 802 for the bits of the mantissa, including a sign bit slice 804 and a plurality of bit slices in descending order, such as high order bit slice 806 and low order bit slice 808. These bit-maps can identify those vectors or rows in the vector database table where a mantissa of a particular dimension has a matching bit, e.g., via a “0” or “1” binary indication stored in values 810 (e.g., b₀, b₁, b₂, to bₘ).

Turning now to example matching or nearest neighbor search processes according to the present disclosure, first note that the matching process can proceed in multiple phases. In one embodiment of a first phase, the system can iterate over the columns in a table of floating-point values, yielding a reduced set of rows that are plausibly similar to the target vector (how “similar” can be determined when initiating the search in certain embodiments). For example, it may be desirable, when initiating a search, to represent ranges for column matching by providing the system with a vector of ranges as an input parameter for either or both of the exponent and mantissa matching actions. Alternatively, the system can be configured to perform an exact search or use a predefined range for searching.

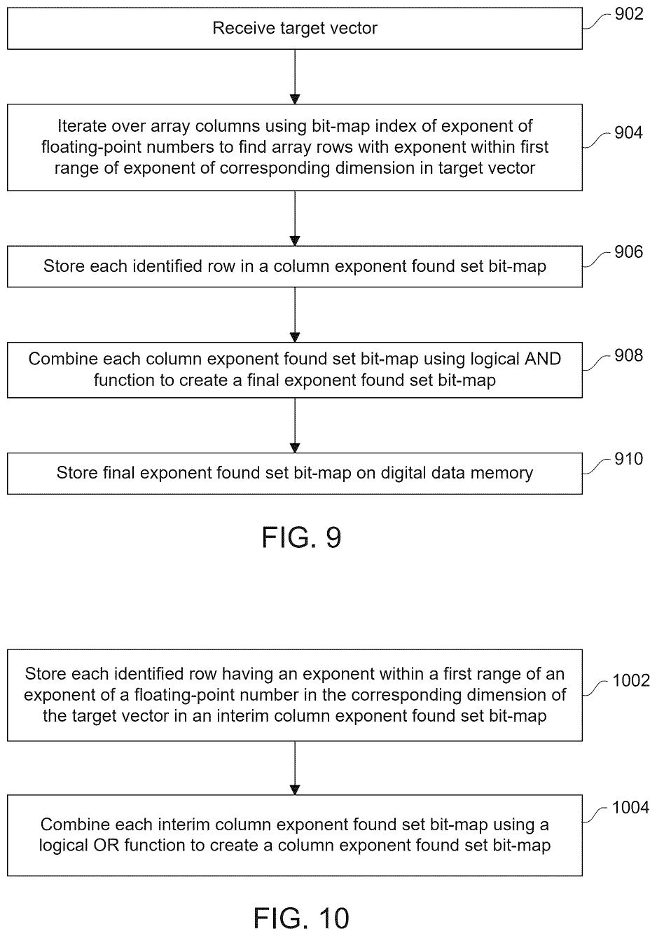

For each column in the table, a bit-map of rows that match the target vector's exponent can be created. A bit-map of rows is, logically, a linear sequence of bits where an ordinal position in the logical sequence corresponds to the same ordinal row in the table. This is referred to as the column exponent found set. The matching can be exact or approximate. An approximate match can allow for any matches that are in a range of values for the exponent. Where an approximate match is requested, a found set bit-map can be developed for each of the values in the range and the final column exponent found set can be constructed by performing a logical (inclusive) OR on all of the approximate value found sets. An example of this process is described in more detail in connection with FIGS. 9 and 10.

An approximate match operation can also be performed on the mantissa sub-column in some embodiments. If a range query has been performed on the mantissa, then the values of all the found set columns are further restricted to those which are also within the specified range of the mantissa value of the target columns.

After iterating over all columns, the found set bit-maps for all of the columns can be ANDed together, yielding a final found set bit-map. This can include combining (logical AND operation) a mantissa sub-column found set bit-map with the exponent sub-column found set bit-map. Though, in some embodiments, the match operation can be performed on the mantissa sub-column after the search space is reduced to only the results found to be within a given range when matching on the exponent. In such an embodiment, there can be no need to combine the found set bit-map from the mantissa search with the found set bit-map from the exponent search because the searched mantissa values were already limited to those returned from the exponent matching process. Regardless, this final found set bit-map has a bit ON for each row in the table where values of all the columns are within a desired measure of similarity (e.g., an order of magnitude, within a given range, match exactly, etc.) of the value of the corresponding element in the target vector.

FIG. 9 illustrates one embodiment of a method for searching an array of floating-point numbers arranged in columns and rows for a nearest neighbor to a target vector. The method can include receiving a target vector of floating-point numbers having a number of dimensions that matches a number of columns in an array of floating-point numbers at step 902. As noted, in many embodiments the number of dimensions can be very large, as in millions or hundreds of millions. It is impractical and/or impossible for humans to operate on such large vectors, and even computer systems can have difficulty in performing operations on such vectors in reasonable amounts of time and at a reasonable cost, which drives the need for improved methods of searching like those disclosed herein.

The method can include iterating over each column of the array of floating-point numbers using a bit-map index of an exponent of each floating-point number in a selected column to identify each row of the array that contains an exponent within a first range of an exponent of a floating-point number in the corresponding dimension of the target vector in step 904. Each identified row can be stored in a column exponent found set bit-map on a digital data memory in step 906.

The method can further include combining each column exponent found set bit-map using a logical AND function to create a final exponent found set bit-map in step 908. And the method can include storing the final exponent found set bit-map on a digital data memory in step 910. The final exponent found set bit-map can identify rows in the array where the exponent of the floating-point number in each column of each identified row is within the first range of the exponent of the floating-point number in the corresponding dimension of the target vector.

In some embodiments, iterating over each column of the array of floating-point numbers using a bit-map index of an exponent of each floating-point number in a selected column to identify each row of the array that contains an exponent within a first range of an exponent of a floating-point number in the corresponding dimension of the target vector and storing each identified row in a column exponent found set bit-map can include, for each column, storing each identified row having an exponent within the first range of an exponent of a floating-point number in the corresponding dimension of the target vector in an interim column exponent found set bit-map. This is shown in step 1002 of FIG. 10. The method can further include combining each interim column exponent found set bit-map using a logical OR function to create the column exponent found set bit-map in step 1004.

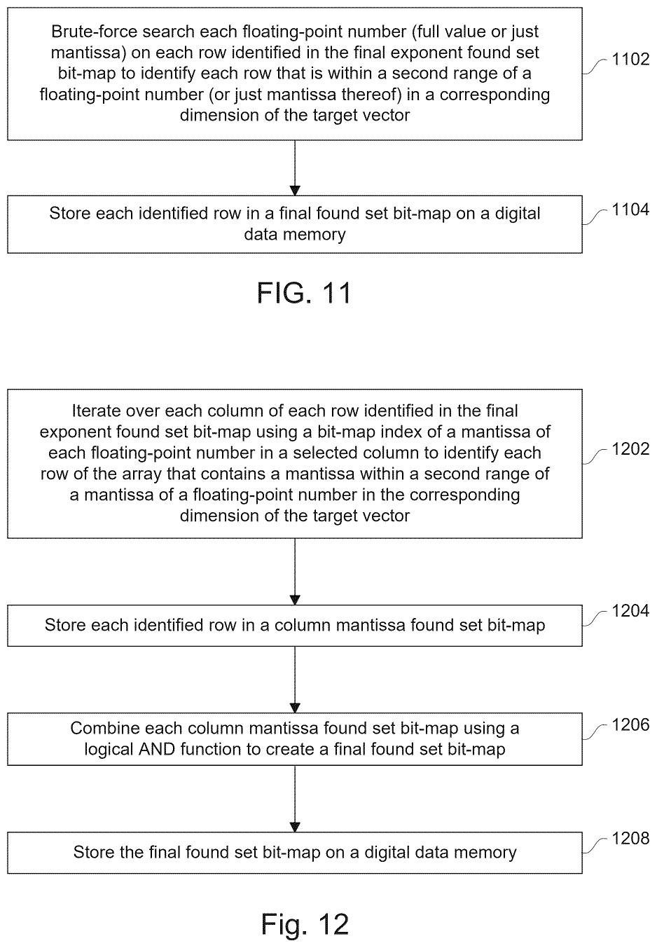

A variety of different search or matching processes are contemplated. For example, under certain circumstances, searching an index of the mantissa may not be useful and an alternative hybrid matching process can utilize the exponent filter to reduce the search space (e.g., by approximately 10× in some cases) and then perform a brute force search on the remaining vectors to provide nearest neighbor results (brute force searching can be performed on any of the full floating-point values in the reduced search space or the mantissa of the floating-point values in the reduced search space). FIG. 11 illustrates one example embodiment where, following the steps shown in FIG. 9, a method can include brute-force searching a mantissa of each floating-point number in each row identified in the final exponent found set bit-map to identify each row that contains a mantissa within a second range of a mantissa of a floating-point number in the corresponding dimension of the target vector. This is shown in step 1102 of FIG. 11. The method can also include storing each identified row in a final found set bit-map in step 1104.

FIG. 12 illustrates one embodiment of a method where, following the steps shown in FIG. 9, an index-based search of the mantissa is utilized. At step 1202, the method includes iterating over each column of each row identified in the final exponent found set bit-map using a bit-map index of a mantissa of each floating-point number in a selected column to identify each row of the array that contains a mantissa within a second range of a mantissa of a floating-point number in the corresponding dimension of the target vector. The method further includes storing each identified row in a column mantissa found set bit-map in step 1204.

The method can further include combining each column mantissa found set bit-map using a logical AND function to create a final found set bit-map in step 1206. Still further, the method can include storing the final found set bit-map on a digital data memory in step 1208. The final found set bit-map can identify rows in the array where the exponent of the floating-point number in each column of each identified row is within the first range of the exponent of the floating-point number in the corresponding dimension of the target vector and the mantissa of the floating-point number in each column of each identified row is within the second range of the mantissa of the floating-point number in the corresponding dimension of the target vector.

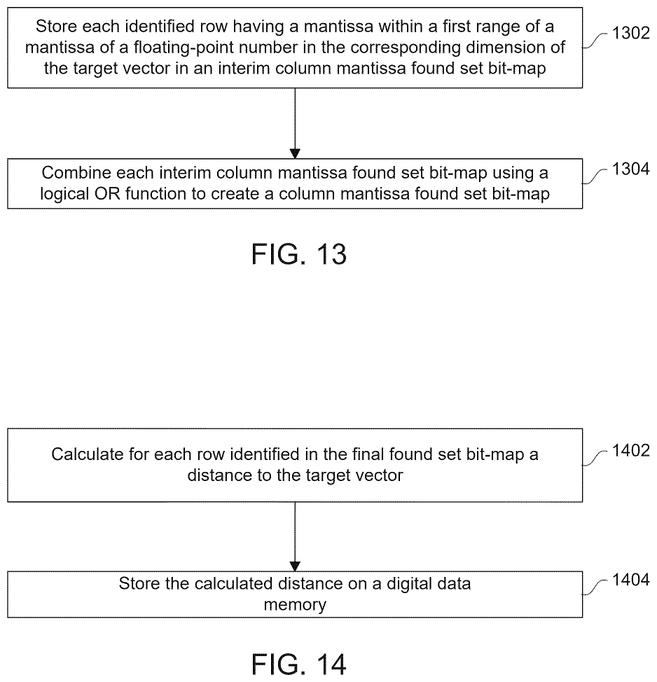

In some embodiments, iterating over each column of each row identified in the final exponent found set bit-map using a bit-map index of a mantissa of each floating-point number in a selected column to identify each row of the array that contains a mantissa within a second range of a mantissa of a floating-point number in the corresponding dimension of the target vector and storing each identified row in a column mantissa found set bit-map can include, for each column, storing each identified row having a mantissa within the second range of a mantissa of a floating-point number in the corresponding dimension of the target vector in an interim column mantissa found set bit-map. This is shown in step 1302 of FIG. 13. The method can further include combining each interim column mantissa found set bit-map using a local OR function to create the column mantissa found set bit-map in step 1304.

In a second phase, the set of rows identified in the first phase can be iterated over and each row scored for how similar it is to the target. The scoring process can yield an unordered list of row identifiers and their similarity score. The scoring mechanism can be any useful vector nearness method, including distance-based methods, such as Euclidean distance, cosine similarity, etc.

In some embodiments, an example method can include calculating for each row identified in the final found set bit-map a distance to the target vector. This is shown in step 1402 of FIG. 14. The method can also include storing the calculated distance on a digital data memory in step 1404. In some embodiments, the calculation of distance to a target vector can be performed using a GPU 104 of a computer vector processing system 100.

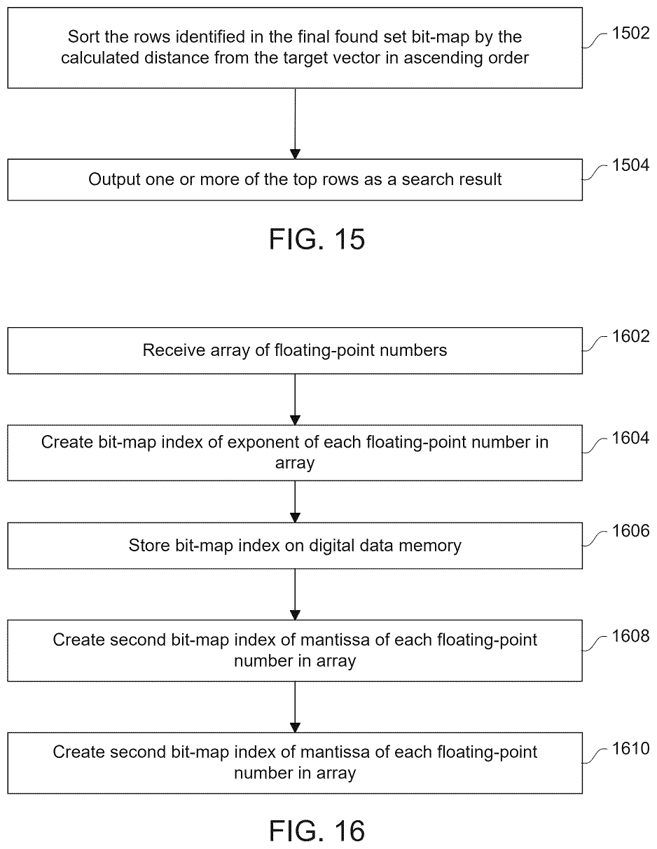

In a third phase, the scored rows (vectors) can be sorted by score and the top n row identifiers, i.e., the identifiers corresponding to the n rows most similar to the target vector, can be the output of the process. FIG. 15 illustrates an example method that includes sorting the rows identified in the final found set bit-map by the calculated distance in ascending order in step 1502. In such an example, the nearest neighbors will have the lowest distance value. The method further includes outputting one or more of the top rows as a nearest neighbor to the target vector in step 1504.

FIG. 16 illustrates another example method for accelerating search of floating-point numbers arranged in columns and rows for a nearest neighbor to a target vector. The method can include receiving an array of floating-point numbers arranged in columns and rows in step 1602. As noted above, the array of floating-point numbers can include a number of columns and rows that are each are in the millions, hundreds of millions, or more. It is impractical and/or impossible for humans to operate on such large datasets, and even computer systems can have difficulty in performing operations on such datasets in reasonable amounts of time and at a reasonable cost, which drives the need for methods of accelerating searching such datasets like those disclosed herein.

The method can include creating a bit-map index of an exponent of each floating-point number in the array, as shown in step 1604 of FIG. 16. The method can further include storing the bit-map index on a digital data memory in step 1606.

In some embodiments, the method can further include creating a second bit-map index of a mantissa of each floating-point number in the array, as shown in step 1608. And the method can include storing the second bit-map index on the digital data memory, as shown in step 1610.

In some embodiments, the exponent of each floating-point number in an array can be indexed using a low-cardinality bit-map index. In certain embodiments, the mantissa of each floating-point number in the array can also be indexed using a low-cardinality bit-map index. In some embodiments, however, the mantissa of each floating-point number in the array can be indexed with a high-cardinality bit-map index instead.

As noted above, in addition to bit-map indexes for the individual columns and sub-columns of a table of vectors, the system can maintain a bit-map for each table that indicates whether or not each row has been deleted. If the row is present, then the corresponding deleted bit can be ON. If the row has been deleted, then the corresponding deleted bit can be OFF. Match operations can logically AND the deleted row bit-map with either intermediate or final found sets in order to exclude the deleted row from phase two and phase three of the matching process.

In the event that NULL values are permitted within a vector, each sub-column can include a bit-map that contains an ON bit for each row where there is not a NULL value, i.e., for each row that has a value present, and an OFF bit for each row that does not have a value present, i.e., is NULL. The null values bit map can then be logically ANDed with the result of any sub-column selection performed as part of phase one of the matching process.

The disclosed systems and methods can exploit parallelization throughout the processing, at least in part as follows:

Parallelize operations across sub-columns: each sub-column operation can be performed independently of, and in parallel with, all other sub-column operations.

Parallelize bit-map operations: operations on one section of a bit-map can be independent of operations on any other disjoint section of the bit-map. The bit-map can be divided into disjoint segments and operations performed on those sections in parallel. If the bit-map is implemented as a tree of pages, as noted above, bit-map operations can be parallelized on pages or disjoint sets of pages.

Bit-map pages can be stored across multiple storage devices. Some storage devices can support user implemented processing in the storage controller (e.g., storage controller 116). By locating the bit-map operations in a programmable storage controller 116, a higher-level main central processing unit 102 can be relieved of the processing load associated with bit-map operations and can perform other operations in parallel with phase one of the process described above. These different-level processing units, storage controllers, and storage devices are shown schematically in FIG. 1 and described above.

Most modern central processing units include vector processing instructions 110. Bit-map operations can be accelerated by performing them in parallel using the vector processing unit or instructions 110 of a central processor 102. See, e.g., the example central processing unit 102 of FIG. 1 described above.

The output bit-maps from phase one of the disclosed method described above can be streamed as the input to phase two, i.e., the scoring process. In this way, scoring can be overlapped with matching to improve throughput.

In some embodiments, the scoring process can be performed in a graphics processing unit (GPU). See, e.g., the example GPU 104 of FIG. 1. This again allows or parallelizing operations and performing operations on the best-suited computing hardware, thereby freeing up resources from other hardware, such as the CPU 102, and improving computer system performance.

In certain embodiments, bit-map operations can be performed in a GPU. See, e.g., the example GPU 104 of FIG. 1. This again allows advantages of parallelizing operations, performing operations on the best-suited computing hardware (e.g., to free up computing resources of the CPU 102, etc.), and thereby improving overall system performance.

In certain embodiments, bit-map operations can be performed using a programmable storage controller of one or more digital data storage devices, such as the storage controller 116 of storage device 106 shown in FIG. 1. This can be done as an alternative to performing such operations using other digital processors, such as the CPU 102 and/or GPU 104, as noted above. Still further, in certain embodiments the various bit-map operations can be divided among a plurality of digital processors, e.g., performing some portion of the required operations on the CPU 102, GPU 104, and/or storage controller 116.

Many of these techniques can be combined to yield a system that achieves both high throughput and fast response times while also optimizing device utilization.

The systems and methods disclosed herein have utility in a variety of use cases or applications. One example (and quite popular) use of vector similarity search is in Retrieval Augmented Generation (RAG). This is when an enterprise uses a machine learning model based on so-called “deep learning” (e.g., a neural network with>1 hidden layer) that has been trained on that enterprise's data to augment the knowledge base available to a general purpose large language model (LLM; such as ChatGPT, Gemini, Grok, etc.). A key step in “augmentation” of RAG is to export the weights in the neural network associated with each element of content as a vector. There is a vector for each content element and there are commonly millions of these elements. The number of dimensions is a function of the specific model and can range (typically) from as low as 128 to 1536 and higher. Each point in hyperspace (multi-dimensional space) implied by the number of dimensions is considered a point in a semantic space and the “closer” one point is to another (according to some mathematically defined distance metric) in the hyperspace indicates the closer the two points are in meaning. This is useful for identifying items in a large inventory that are similar to each other, for example, in providing shopping recommendations in an electronic commerce application or suggesting a next show to watch in an entertainment streaming application. Another example is recognizing and ranking similarity across chemical compounds or across genomes in research and product development contexts.

The systems and methods disclosed herein can produce significant performance improvements in computer systems executing nearest neighbor searches on large vector datasets. Recent measurements suggest performance gains over existing brute force implementations of exact search that range from 80×-170×. It is believed that a significant portion of this comes from the reduction in search space by using a range look-up on one sub-column of the floating-point values (e.g., the exponent) before searching the other sub-column values (e.g., the mantissa). Separating the exponent from the mantissa in standard floating-point representations and indexing the two separately allows for quantizing the dataset based on one of these values (e.g., the exponent) and thereby significantly reducing the search space for completing the search on the other value (e.g., the mantissa). Additional performance improvements can be achieved from the effective use of parallelization on multi-core computers. As noted above, the systems and methods disclosed herein are particularly suited to parallelization throughout the process. There is also substantial improvement in insert (or ingest) performance. Practically, this means that vector datasets can be kept (made) current as enterprise information changes over time. While updating these datasets is always possible (necessary, even), prior approximate search methods require much longer ingest times than those disclosed herein. This means a user can update data much more frequently.

In this disclosure, articles “a” and “an” are used to refer to one or to more than one (i.e., at least one) of the grammatical object of the article. By way of example, “an element” means at least one element and can include more than one element. The term “about” is used to provide flexibility to a numerical range endpoint by providing that a given value may be “slightly above” or “slightly below” the endpoint without affecting the desired result. The use herein of the terms “including,” “comprising,” or “having,” and variations thereof, is meant to encompass the elements listed thereafter and equivalents thereof, as well as additional elements. As used herein, “and/or” refers to and encompasses any and all possible combinations of one or more of the associated listed items, as well as the lack of combinations where interpreted in the alternative (“or”). Further, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B,” “one or more of A and B,” and “A and/or B” are each intended to mean “A alone, B alone, or A and B together.” A similar interpretation is also intended for lists including three or more items. For example, the phrases “at least one of A, B, and C,” “one or more of A, B, and C,” and “A, B, and/or C” are each intended to mean “A alone, B alone, C alone, A and B together, A and C together, B and C together, or A and B and C together.” In addition, use of the term “based on,” is intended to mean, “based at least in part on,” such that an un-recited feature or element is also permissible.

Further features and advantages based on the above-described embodiments are possible and within the scope of the present disclosure. Accordingly, the disclosure is not to be limited by what has been particularly shown and described. All publications and references cited herein are expressly incorporated herein by reference in their entirety, except for any definitions, subject matter disclaimers, or disavowals, and except to the extent that the incorporated material is inconsistent with the express disclosure herein, in which case the language in this disclosure controls.

Examples of the above-described embodiments can include the following:
1. A method for accelerating search and similarity matching of arrays of digital floating-point numbers (of some specified precision) using bit mapped indexes and treating the exponent and the mantissa of each floating-point element of the array as two separately indexable components, the exponent and the mantissa.
2. The method of example 1, wherein the exponent of each column of the array is indexed using a low-cardinality bit-map index.
3. The method of example 1, wherein the mantissa of each column of the array is indexed using a low-cardinality bit-map index.
4. The method of example 1, wherein the mantissa of each column of the array is indexed using a high-cardinality bit-map index.
5. A vector database management system that implements the method of example 1 as an indexing and search method for retrieving a set of vectors in a dataset stored in a database that are most similar to a target vector presented as an argument to the system.
6. A method for searching an array of digital floating-point numbers arranged in columns and rows for a nearest neighbor to a target vector, comprising:
   receiving a target vector of digital floating-point numbers having a number of dimensions that matches a number of columns in an array of digital floating-point numbers;
   iterating over each column of the array of digital floating-point numbers using a bit-map index of an exponent of each floating-point number in a selected column to identify each row of the array that contains an exponent within a first range of an exponent of a floating-point number in the corresponding dimension of the target vector and storing each identified row in a column exponent found set bit-map on a digital data memory;
   combining each column exponent found set bit-map using a logical AND function to create a final exponent found set bit-map; and
   storing the final exponent found set bit-map on the digital data memory, the final exponent found set bit-map identifying rows in the array where the exponent of the floating-point number in each column of each identified row is within the first range of the exponent of the floating-point number in the corresponding dimension of the target vector.
7. The method of example 6, wherein iterating over each column of the array of digital floating-point numbers using a bit-map index of an exponent of each floating-point number in a selected column to identify each row of the array that contains an exponent within a first range of an exponent of a floating-point number in the corresponding dimension of the target vector and storing each identified row in a column exponent found set bit-map includes, for each column:
   storing each identified row having an exponent within the first range of an exponent of a floating-point number in the corresponding dimension of the target vector in an interim column exponent found set bit-map; and
   combining each interim column exponent found set bit-map using a logical OR function to create the column exponent found set bit-map.
8. The method of any of examples 6 to 7, further comprising:
   brute-force searching a mantissa of each digital floating-point number in each row identified in the final exponent found set bit-map to identify each row that contains a mantissa within a second range of a mantissa of a floating-point number in the corresponding dimension of the target vector and storing each identified row in a final found set bit-map; and
   storing the final found set bit-map on the digital data memory, the final found set bit-map identifying rows in the array where the exponent of the floating-point number in each column of each identified row is within the first range of the exponent of the floating-point number in the corresponding dimension of the target vector and the mantissa of the floating-point number in each column of each identified row is within the second range of the mantissa of the floating-point number in the corresponding dimension of the target vector.
9. The method of any of examples 6 to 7, further comprising:
   brute-force searching each digital floating-point number in each row identified in the final exponent found set bit-map to identify each row that contains a floating-point number within a second range of a floating-point number in the corresponding dimension of the target vector and storing each identified row in a final found set bit-map; and
   storing the final found set bit-map on the digital data memory, the final found set bit-map identifying rows in the array where the exponent of the floating-point number in each column of each identified row is within the first range of the exponent of the floating-point number in the corresponding dimension of the target vector and the floating-point number in each column of each identified row is within the second range of the floating-point number in the corresponding dimension of the target vector.
10. The method of example 6, further comprising:
   iterating over each column of each row identified in the final exponent found set bit-map using a bit-map index of a mantissa of each floating-point number in a selected column to identify each row of the array that contains a mantissa within a second range of a mantissa of a floating-point number in the corresponding dimension of the target vector and storing each identified row in a column mantissa found set bit-map;
   combining each column mantissa found set bit-map using a logical AND function to create a final found set bit-map; and
   storing the final found set bit-map on a digital data memory, the final found set bit-map identifying rows in the array where the exponent of the floating-point number in each column of each identified row is within the first range of the exponent of the floating-point number in the corresponding dimension of the target vector and the mantissa of the floating-point number in each column of each identified row is within the second range of the mantissa of the floating-point number in the corresponding dimension of the target vector.
11. The method of example 10, wherein iterating over each column of each row identified in the final exponent found set bit-map using a bit-map index of a mantissa of each floating-point number in a selected column to identify each row of the array that contains a mantissa within a second range of a mantissa of a floating-point number in the corresponding dimension of the target vector and storing each identified row in a column mantissa found set bit-map includes, for each column:
   storing each identified row having a mantissa within the second range of a mantissa of a floating-point number in the corresponding dimension of the target vector in an interim column mantissa found set bit-map; and
   combining each interim column mantissa found set bit-map using a local OR function to create the column mantissa found set bit-map.
12. The method of any of examples 8 to 11, further comprising calculating for each row identified in the final found set bit-map a distance to the target vector and storing the calculated distance on a digital data memory.
13. The method of example 12, wherein calculating for each row identified in the final found set bit-map a distance to the target vector is performed using a Graphics Processing Unit (GPU) of a computer system.
14. The method of any of examples 12 to 13, further comprising sorting the rows identified in the final found set bit-map by the calculated distance in ascending order and outputting one or more of the top rows as a nearest neighbor to the target vector.
15. The method of any of examples 6 to 14, wherein the exponent of each floating-point number in the array is indexed using a low-cardinality bit-map index.
16. The method of any of examples 10 to 15, wherein the mantissa of each floating-point number in the array is indexed using a low-cardinality bit-map index.
17. The method of any of examples 10 to 15, wherein the mantissa of each floating-point number in the array is indexed using a high-cardinality bit-map index.
18. The method of any of examples 6 to 17, wherein bit-map operations are performed using a programmable storage controller of one or more storage devices.
19. The method of any of examples 6 to 17, wherein bit-map operations are performed using a vector processing unit of a Central Processing Unit (CPU).
20. The method of any of examples 6 to 17, wherein bit-map operations are performed using a Graphics Processing Unit (GPU).
21. A method for accelerating search of digital floating-point numbers arranged in columns and rows for a nearest neighbor to a target vector, comprising:
   receiving an array of digital floating-point numbers arranged in columns and rows; and
   creating a bit-map index of an exponent of each floating-point number in the array; and
   storing the bit-map index on a digital data memory.
22. The method example 21, wherein the bit-map index is a low-cardinality bit-map index.
23. The method of any of examples 21 to 22, further comprising creating a second bit-map index of a mantissa of each digital floating-point number in the array and storing the second bit-map index on the digital data memory.
24. The method of example 23, wherein the second bit-map index is a low-cardinality bit-map index.
25. The method of example 23, wherein the second bit-map index is a high-cardinality bit-map index.
26. A system for vector database management, comprising:
   a digital data processor; and
   a digital data memory having an array of digital floating-point numbers and a bit-map index of an exponent of each floating-point number in the array stored thereon;
   wherein the digital data processor is configured to:
      receive a target vector of digital floating-point numbers having a number of dimensions that matches a number of columns in the array of digital floating-point numbers;
      iterate over each column of the array of digital floating-point numbers using the bit-map index of the exponent of each floating-point number in a selected column to identify each row of the array that contains an exponent within a first range of an exponent of a floating-point number in the corresponding dimension of the target vector and store each identified row in a column exponent found set bit-map on the digital data memory; and
   combine each column exponent found set bit-map using a logical AND function to create a final exponent found set bit-map; and
   store the final exponent found set bit-map on the digital data memory, the final exponent found set bit-map identifying rows in the array where the exponent of the floating-point number in each column of each identified row is within the first range of the exponent of the floating-point number in the corresponding dimension of the target vector.
27. The system of example 26, wherein the digital data processor is further configured to:
   brute-force search a mantissa of each floating-point number in each row identified in the final exponent found set bit-map to identify each row that contains a mantissa within a second range of a mantissa of a floating-point number in the corresponding dimension of the target vector and store each identified row in a final found set bit-map; and
   store the final found set bit-map on the digital data memory, the final found set bit-map identifying rows in the array where the exponent of the floating-point number in each column of each identified row is within the first range of the exponent of the floating-point number in the corresponding dimension of the target vector and the mantissa of the floating-point number in each column of each identified row is within the second range of the mantissa of the floating-point number in the corresponding dimension of the target vector.
28. The system of example 26, wherein the digital data processor is further configured to:
   brute-force search each floating-point number in each row identified in the final exponent found set bit-map to identify each row that contains a floating-point number within a second range of a floating-point number in the corresponding dimension of the target vector and store each identified row in a final found set bit-map; and
   store the final found set bit-map on the digital data memory, the final found set bit-map identifying rows in the array where the exponent of the floating-point number in each column of each identified row is within the first range of the exponent of the floating-point number in the corresponding dimension of the target vector and the floating-point number in each column of each identified row is within the second range of the floating-point number in the corresponding dimension of the target vector.
29. The system of example 26, wherein the digital data memory has a second bit-map index of a mantissa of each floating-point number in the array stored thereon and the digital data processor is further configured to:
   iterate over each column of each row identified in the final exponent found set bit-map using the bit-map index of the mantissa of each floating-point number in a selected column to identify each row of the array that contains a mantissa within a second range of a mantissa of a floating-point number in the corresponding dimension of the target vector and store each identified row in a column mantissa found set bit-map;
   combine each column mantissa found set bit-map using a logical AND function to create a final found set bit-map; and
   store the final found set bit-map on the digital data memory, the final found set bit-map identifying rows in the array where the exponent of the floating-point number in each column of each identified row is within the first range of the exponent of the floating-point number in the corresponding dimension of the target vector and the mantissa of the floating-point number in each column of each identified row is within the second range of the mantissa of the floating-point number in the corresponding dimension of the target vector.
30. The system of any of examples 26 to 29, wherein the digital data processor is further configured to calculate for each row identified in the final found set bit-map a distance to the target vector and store the calculated distance on the digital data memory.
31. The system of example 30, wherein the digital data processor is further configured to sort the rows identified in the final found set bit-map by the calculated distance in ascending order and output one or more of the top rows as a nearest neighbor to the target vector.
32. The system of any of examples 26 to 31, wherein the exponent of each floating-point number in the array is indexed using a low-cardinality bit-map index.
33. The system of any of examples 29 to 32, wherein the mantissa of each floating-point number in the array is indexed using a low-cardinality bit-map index.
34. The system of any of examples 29 to 32, wherein the mantissa of each floating-point number in the array is indexed using a high-cardinality bit-map index.
35. A non-transitory computer-readable medium storing instructions that, when executed by one or more processors, cause the one or more processors to perform operations comprising:
   receiving a target vector of digital floating-point numbers having a number of dimensions that matches a number of columns in an array of digital floating-point numbers arranged in columns and rows;
   iterating over each column of the array of digital floating-point numbers using a bit-map index of an exponent of each floating-point number in a selected column to identify each row of the array that contains an exponent within a first range of an exponent of a floating-point number in the corresponding dimension of the target vector and storing each identified row in a column exponent found set bit-map on a digital data memory;
   combining each column exponent found set bit-map using a logical AND function to create a final exponent found set bit-map; and
   storing the final exponent found set bit-map on a digital data memory, the final exponent found set bit-map identifying rows in the array where the exponent of the floating-point number in each column of each identified row is within the first range of the exponent of the floating-point number in the corresponding dimension of the target vector.
36. The non-transitory computer-readable medium of example 35, wherein the instructions, when executed by the one or more processors, further cause the one or more processors to:
   brute-force search a mantissa of each floating-point number in each row identified in the final exponent found set bit-map to identify each row that contains a mantissa within a second range of a mantissa of a floating-point number in the corresponding dimension of the target vector and store each identified row in a final found set bit-map; and
   store the final found set bit-map on the digital data memory, the final found set bit-map identifying rows in the array where the exponent of the floating-point number in each column of each identified row is within the first range of the exponent of the floating-point number in the corresponding dimension of the target vector and the mantissa of the floating-point number in each column of each identified row is within the second range of the mantissa of the floating-point number in the corresponding dimension of the target vector.
37. The non-transitory computer-readable medium of example 35, wherein the instructions, when executed by the one or more processors, further cause the one or more processors to:
   brute-force search each floating-point number in each row identified in the final exponent found set bit-map to identify each row that contains a floating-point number within a second range of a floating-point number in the corresponding dimension of the target vector and store each identified row in a final found set bit-map; and
   store the final found set bit-map on the digital data memory, the final found set bit-map identifying rows in the array where the exponent of the floating-point number in each column of each identified row is within the first range of the exponent of the floating-point number in the corresponding dimension of the target vector and the floating-point number in each column of each identified row is within the second range of the floating-point number in the corresponding dimension of the target vector.
38. The non-transitory computer-readable medium of example 35, wherein the instructions, when executed by the one or more processors, further cause the one or more processors to:
   iterate over each column of each row identified in the final exponent found set bit-map using the bit-map index of the mantissa of each floating-point number in a selected column to identify each row of the array that contains a mantissa within a second range of a mantissa of a floating-point number in the corresponding dimension of the target vector and store each identified row in a column mantissa found set bit-map;
   combine each column mantissa found set bit-map using a logical AND function to create a final found set bit-map; and
   store the final found set bit-map on the digital data memory, the final found set bit-map identifying rows in the array where the exponent of the floating-point number in each column of each identified row is within the first range of the exponent of the floating-point number in the corresponding dimension of the target vector and the mantissa of the floating-point number in each column of each identified row is within the second range of the mantissa of the floating-point number in the corresponding dimension of the target vector.
39. The non-transitory computer-readable medium of any of examples 35 to 38, wherein the instructions, when executed by the one or more processors, further cause the one or more processors to calculate for each row identified in the final found set bit-map a distance to the target vector and store the calculated distance on the digital data memory.
40. The non-transitory computer-readable medium of example 39, wherein the instructions, when executed by the one or more processors, further cause the one or more processors to sort the rows identified in the final found set bit-map by the calculated distance in ascending order and output one or more of the top rows as a nearest neighbor to the target vector.
41. The non-transitory computer-readable medium of any of examples 35 to 40, wherein the exponent of each floating-point number in the array is indexed using a low-cardinality bit-map index.
42. The non-transitory computer-readable medium of any of examples 38 to 41, wherein the mantissa of each floating-point number in the array is indexed using a low-cardinality bit-map index.
43. The non-transitory computer-readable medium of any of examples 38 to 41, wherein the mantissa of each floating-point number in the array is indexed using a high-cardinality bit-map index.

1. A method for searching an array of digital floating-point numbers arranged in columns and rows for a nearest neighbor to a target vector, comprising:
receiving a target vector of digital floating-point numbers having a number of dimensions that matches a number of columns in an array of digital floating-point numbers;
iterating over each column of the array of digital floating-point numbers using a bit-map index of an exponent of each floating-point number in a selected column to identify each row of the array that contains an exponent within a first range of an exponent of a floating-point number in the corresponding dimension of the target vector and storing each identified row in a column exponent found set bit-map on a digital data memory;
combining each column exponent found set bit-map using a logical AND function to create a final exponent found set bit-map;
storing the final exponent found set bit-map on the digital data memory, the final exponent found set bit-map identifying rows in the array where the exponent of the floating-point number in each column of each identified row is within the first range of the exponent of the floating-point number in the corresponding dimension of the target vector;
iterating over each column of each row identified in the final exponent found set bit-map using a bit-map index of a mantissa of each floating-point number in a selected column to identify each row of the array that contains a mantissa within a second range of a mantissa of a floating-point number in the corresponding dimension of the target vector and storing each identified row in a column mantissa found set bit-map;
combining each column mantissa found set bit-map using a logical AND function to create a final found set bit-map; and
storing the final found set bit-map on a digital data memory, the final found set bit-map identifying rows in the array where the exponent of the floating-point number in each column of each identified row is within the first range of the exponent of the floating-point number in the corresponding dimension of the target vector and the mantissa of the floating-point number in each column of each identified row is within the second range of the mantissa of the floating-point number in the corresponding dimension of the target vector.

2. The method of claim 1, wherein iterating over each column of the array of digital floating-point numbers using a bit-map index of an exponent of each floating-point number in a selected column to identify each row of the array that contains an exponent within a first range of an exponent of a floating-point number in the corresponding dimension of the target vector and storing each identified row in a column exponent found set bit-map includes, for each column:
storing each identified row having an exponent within the first range of an exponent of a floating-point number in the corresponding dimension of the target vector in an interim column exponent found set bit-map; and
combining each interim column exponent found set bit-map using a logical OR function to create the column exponent found set bit-map.

3. (canceled)

4. (canceled)

5. (canceled)

6. The method of claim 1, wherein iterating over each column of each row identified in the final exponent found set bit-map using a bit-map index of a mantissa of each floating-point number in a selected column to identify each row of the array that contains a mantissa within a second range of a mantissa of a floating-point number in the corresponding dimension of the target vector and storing each identified row in a column mantissa found set bit-map includes, for each column:
storing each identified row having a mantissa within the second range of a mantissa of a floating-point number in the corresponding dimension of the target vector in an interim column mantissa found set bit-map; and
combining each interim column mantissa found set bit-map using a local OR function to create the column mantissa found set bit-map.

7. (canceled)

8. (canceled)

9. (canceled)

10. The method of claim 1, wherein the exponent of each floating-point number in the array is indexed using a low-cardinality bit-map index.

11. The method of claim 1, wherein the mantissa of each floating-point number in the array is indexed using a low-cardinality bit-map index.

12. The method of claim 1, wherein the mantissa of each floating-point number in the array is indexed using a high-cardinality bit-map index.

13. The method of claim 1, wherein bit-map operations are performed using a programmable storage controller of one or more storage devices.

14. The method of claim 1, wherein bit-map operations are performed using a vector processing unit of a Central Processing Unit (CPU).

15. The method of claim 1, wherein bit-map operations are performed using a Graphics Processing Unit (GPU).

16. (canceled)

17. (canceled)

18. (canceled)

19. (canceled)

20. A vector database management system that implements the method of claim 1 as an indexing and search method for retrieving a set of vectors in a dataset stored in a database that are most similar to a target vector presented as an argument to the system.

21. A method for searching an array of digital floating-point numbers arranged in columns and rows for a nearest neighbor to a target vector, comprising:
receiving a target vector of digital floating-point numbers having a number of dimensions that matches a number of columns in an array of digital floating-point numbers;
iterating over each column of the array of digital floating-point numbers using a bit-map index of an exponent of each floating-point number in a selected column to identify each row of the array that contains an exponent within a first range of an exponent of a floating-point number in the corresponding dimension of the target vector and storing each identified row in a column exponent found set bit-map on a digital data memory;
combining each column exponent found set bit-map using a logical AND function to create a final exponent found set bit-map;
storing the final exponent found set bit-map on the digital data memory, the final exponent found set bit-map identifying rows in the array where the exponent of the floating-point number in each column of each identified row is within the first range of the exponent of the floating-point number in the corresponding dimension of the target vector;
brute-force searching each digital floating-point number in each row identified in the final exponent found set bit-map to identify each row that contains a floating-point number within a second range of a floating-point number in the corresponding dimension of the target vector and storing each identified row in a final found set bit-map; and
storing the final found set bit-map on the digital data memory, the final found set bit-map identifying rows in the array where the exponent of the floating-point number in each column of each identified row is within the first range of the exponent of the floating-point number in the corresponding dimension of the target vector and the floating-point number in each column of each identified row is within the second range of the floating-point number in the corresponding dimension of the target vector.

22. A method for searching an array of digital floating-point numbers arranged in columns and rows for a nearest neighbor to a target vector, comprising:
receiving a target vector of digital floating-point numbers having a number of dimensions that matches a number of columns in an array of digital floating-point numbers;
iterating over each column of the array of digital floating-point numbers using a bit-map index of an exponent of each floating-point number in a selected column to identify each row of the array that contains an exponent within a first range of an exponent of a floating-point number in the corresponding dimension of the target vector and storing each identified row in a column exponent found set bit-map on a digital data memory;
combining each column exponent found set bit-map using a logical AND function to create a final exponent found set bit-map;
storing the final exponent found set bit-map on the digital data memory, the final exponent found set bit-map identifying rows in the array where the exponent of the floating-point number in each column of each identified row is within the first range of the exponent of the floating-point number in the corresponding dimension of the target vector;
brute-force searching a mantissa of each digital floating-point number in each row identified in the final exponent found set bit-map to identify each row that contains a mantissa within a second range of a mantissa of a floating-point number in the corresponding dimension of the target vector and storing each identified row in a final found set bit-map; and
storing the final found set bit-map on the digital data memory, the final found set bit-map identifying rows in the array where the exponent of the floating-point number in each column of each identified row is within the first range of the exponent of the floating-point number in the corresponding dimension of the target vector and the mantissa of the floating-point number in each column of each identified row is within the second range of the mantissa of the floating-point number in the corresponding dimension of the target vector.

23. The method of claim 22, further comprising calculating for each row identified in the final found set bit-map a distance to the target vector and storing the calculated distance on a digital data memory.

24. The method of claim 23, wherein calculating for each row identified in the final found set bit-map a distance to the target vector is performed using a Graphics Processing Unit (GPU) of a computer system.

25. The method of claim 23, further comprising sorting the rows identified in the final found set bit-map by the calculated distance in ascending order and outputting one or more of the top rows as a nearest neighbor to the target vector.
